(19) United States
(12) Patent Application Publication
(10) Pub. No.: US 2025/0377704 A1
(43) Pub. Date: Dec. 11, 2025

(54) ELECTRONIC DEVICE FOR COMMUNICATING WITH HOST AND OPERATING METHOD THEREOF

(71) Applicant: Wistron Corporation, New Taipei City (TW)

(72) Inventors: Lei Sun, New Taipei City (TW); Lei Yang, New Taipei City (TW); Yongqiang Li, New Taipei City (TW); Lixing Zhu, New Taipei City (TW); Junxin Qiu, New Taipei City (TW)

(73) Assignee: Wistron Corporation, New Taipei City (TW)

(21) Appl. No.: 18/764,083

(22) Filed: Jul. 3, 2024

(30) Foreign Application Priority Data
Jun. 11, 2024 (CN) 202410750530.1

(51) Int. Cl. G06F 1/26

(52) U.S. Cl. CPC G06F 1/266

(57) ABSTRACT

An electronic device for communicating with a host and an operating method thereof are provided. The electronic device includes a plurality of functional circuits, a plurality of power sensors, a processor, a communication port, and a network communication interface. Each of the plurality of power sensors senses power of one of the plurality of functional circuits to provide a power sensing signal. The processor collects a plurality of power sensing signals from the plurality of power sensors and generates a plurality of power values corresponding to the plurality of functional circuits based on the plurality of power sensing signals. The network communication interface provides the plurality of power values to the host through the communication port.

### CROSS-REFERENCE TO RELATED APPLICATION

This application claims the priority benefit of China application serial no. 202410750530.1, filed on Jun. 11, 2024. The entirety of the above-mentioned patent application is hereby incorporated by reference herein and made a part of this specification.

### BACKGROUND

### Technical Field

The disclosure relates to an electronic device, and particularly relates to an electronic device for communicating with a host and an operating method thereof.

### Description of Related Art

At present, all enterprises are actively reducing carbon emissions to accelerate green and low-carbon transformation. In addition, tracking the carbon footprint of products has also begun to receive attention. The entire life cycle of an electronic device includes at least the raw material extraction stage, production stage, transportation stage, usage stage, and end of life cycle stage. The usage stage has the largest carbon emissions. Therefore, the power consumption value during the usage stage of the electronic device must be tracked. Therefore, how to provide an electronic device that can actively provide the power consumption value is one of the research focuses of those skilled in the art.

### SUMMARY

The disclosure provides an electronic device for communicating with a host and an operating method thereof, which can actively provide the power value to the host.

An embodiment of the disclosure provides an electronic device for communicating with a host. The electronic device includes a plurality of functional circuits, a plurality of power sensors, a processor, a communication port, and a network communication interface. Each of the plurality of power sensors senses power of one of the plurality of functional circuits to provide a power sensing signal. The processor is coupled to the plurality of power sensors. The processor collects a plurality of power sensing signals from the plurality of power sensors and generates a plurality of power values corresponding to the plurality of functional circuits based on the plurality of power sensing signals. The network communication interface is coupled to the processor and the communication port. The network communication interface provides the plurality of power values to the host through the communication port.

An embodiment of the disclosure provides an operating method for communicating with a host including the following steps. Power of a plurality of functional circuits is sensed through a plurality of power sensors to provide a plurality of power sensing signals. The plurality of power sensing signals are collected from the plurality of power sensors. A plurality of power values corresponding to the plurality of functional circuits are generated based on the plurality of power sensing signals. The plurality of power values are provided to the host through a first communication port.

Based on the above, the processor generates the plurality of power values corresponding to the plurality of functional circuits based on the plurality of power sensing signals. The network communication interface provides the plurality of power values to the host through the communication port. In this way, the host can track the carbon footprint of the electronic device during its usage stage.

### BRIEF DESCRIPTION OF THE DRAWINGS

FIG. 1 is a schematic diagram of an electronic device according to an embodiment of the disclosure.

FIG. 2 is a schematic diagram of power sensing signals and power values according to an embodiment of the disclosure.

FIG. 3 is a schematic diagram of an efficiency lookup table according to an embodiment of the disclosure.

FIG. 4 is a schematic diagram of an efficiency value fitting function according to an embodiment of the disclosure.

FIG. 5 is a schematic diagram of an electronic device according to an embodiment of the disclosure.

FIG. 6 is a schematic diagram of an electronic device according to an embodiment of the disclosure.

FIG. 7 is a schematic diagram of a processor, a network communication interface, a routing circuit, and a communication port according to an embodiment of the disclosure.

FIG. 8 is a schematic diagram of a power sensing signal according to an embodiment of the disclosure.

FIG. 9 is a schematic diagram of an operation of an electronic device according to an embodiment of the disclosure.

FIG. 10 is a schematic diagram of an operation of an electronic device according to an embodiment of the disclosure.

FIG. 11 is a schematic diagram of historical data according to an embodiment of the disclosure.

FIG. 12 is a schematic diagram of an update interface according to an embodiment of the disclosure.

FIG. 13 is a flowchart of an operating method according to an embodiment of the disclosure.

### DESCRIPTION OF THE EMBODIMENTS

Some embodiments of the disclosure will be described in detail below with reference to the drawings. When the same reference numerals appear in different drawings, the reference numerals in the following description will be regarded as referring to the same or similar elements. The embodiments are only a part of the disclosure and do not disclose all the possible implementations of the disclosure. More precisely, the embodiments are only examples within the protection scope of the disclosure.

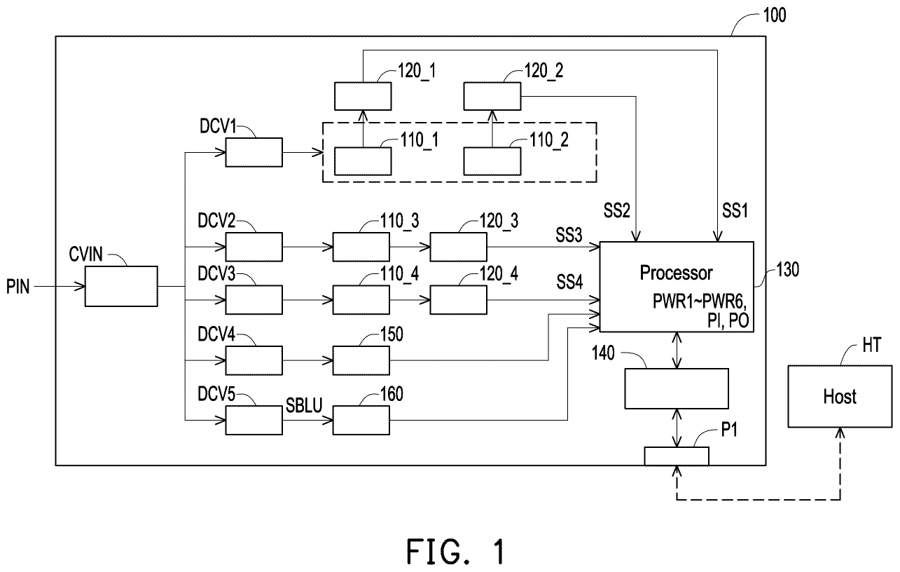

Referring to FIG. 1, FIG. 1 is a schematic diagram of an electronic device according to an embodiment of the disclosure. In an embodiment, an electronic device 100 performs wireless communication and wired communication with a host HT. The host HT can be a server, a laptop, a PC, a tablet, or a smartphone. The electronic device 100 may be a monitor, a laptop, a PC, or an external expansion device (dock), but the disclosure is not limited thereto.

In an embodiment, the electronic device 100 includes functional circuits 110_1 to 110_4, power sensors 120_1 to 120_4, a processor 130, a communication port P1, and a network communication interface 140. The power sensors 120_1 to 120_4 respectively sense the power of one of the functional circuits 110_1 to 110_4 to provide a power sensing signal. For example, the power sensor 120_1 is coupled to the functional circuit 110_1. The power sensor 120_1 senses the power of the functional circuit 110_1 to provide a power sensing signal SS1. The power sensor 120_2 is coupled to the functional circuit 110_2. The power sensor 120_2 senses the power of the functional circuit 110_2 to provide a power sensing signal SS2. The power sensor 120_3 is coupled to the functional circuit 110_3. The power sensor 120_3 senses the power of the functional circuit 110_3 to provide a power sensing signal SS3. The power sensor 120_4 is coupled to the functional circuit 110_4. The power sensor 120_4 senses the power of the functional circuit 110_4 to provide a power sensing signal SS4.

For example, the functional circuit 110_1 may be a display panel. The functional circuit 110_2 may be a panel control circuit. The functional circuit 110_3 may be a connector. The functional circuit 110_4 may be a speaker, but the disclosure is not limited thereto. The panel control circuit can be a timing controller. The display panel may include a pixel array and a driving circuit.

In an embodiment, the processor 130 is coupled to the power sensors 120_1 to 120_4. The processor 130 collects the power sensing signals SS1 to SS4 from the power sensors 120_1 to 120_4. The processor 130 generates power values PWR1 to PWR4 corresponding to the functional circuits 110_1 to 110_4 based on the power sensing signals SS1 to SS4. The power values PWR1 to PWR4 are respectively the power values of consumed power. For example, the processor 130 generates the power value PWR1 of the functional circuit 110_1 based on the power sensing signal SS1. The processor 130 generates the power value PWR2 of the functional circuit 110_2 based on the power sensing signal SS2. The processor 130 generates the power value PWR3 of the functional circuit 110_3 based on the power sensing signal SS3. The processor 130 generates the power value PWR4 of the functional circuit 110_4 based on the power sensing signal SS4.

In an embodiment, the network communication interface 140 is coupled to the processor 130 and the communication port P1. The network communication interface 140 provides the power values PWR1 to PWR4 to the host HT through the communication port P1.

It is worth mentioning here that the processor 130 generates the power values PWR1 to PWR4 corresponding to the functional circuits 110_1 to 110_4 based on the power sensing signals SS1 to SS4. The network communication interface 140 provides the power values PWR1 to

PWR4 to the host HT through the communication port P1. In this way, the host HT can track the carbon footprint of the electronic device 100 during the usage stage immediately or periodically.

In an embodiment, the electronic device 100 further includes an input power converter CVIN and DC power converters DCV1 to DCV3. The input power converter CVIN converts input power PIN to DC power. The DC power converters DCV1 to DCV3 provide driving power based on the DC power. The electronic device 100 uses the driving power provided by the DC power converters DCV1 to DCV3 to drive the functional circuits 110_1 to 110_4. When the functional circuits 110_1 to 110_4 are running, the power consumption and the power consumption value required for the DC power converters DCV1 to DCV3 to provide the driving power can be estimated. Therefore, the electronic device 100 does not need to use additional power sensors to sense the power consumption of the DC power converters DCV1 to DCV3. In some embodiments, the DC power converter DCV1 may be disposed in the functional circuit 110_1. The DC power converter DCV2 may be disposed in the functional circuit 110_3. The DC power converter DCV3 may be disposed in the functional circuit 110_4.

In an embodiment, the electronic device 100 further includes a power supply circuit 150 and a backlight source 160. The power supply circuit 150 is coupled to the processor 130. The power supply circuit 150 supplies power to an external device connected to the electronic device 100. The backlight source 160 is coupled to the processor 130. The backlight source 160 provides a display light source for the display panel (such as the functional circuit 110_2) of the electronic device 100. The processor 130 obtains a power value PWR5 of the power supply circuit 150 based on the power supply requirement of the external device. In addition, the processor 130 obtains a power value PWR6 of the backlight source 160 based on a driving signal SBLU used by the backlight source 160. Furthermore, the processor 130 can obtain the power value PWR6 of the backlight source 160 based on the working period or duty cycle of the driving signal SBLU used by the backlight source 160.

In an embodiment, the electronic device 100 can use the driving power provided by DC power converters DCV4 and DCV5 to drive the power supply circuit 150 and the backlight source 160. When the power supply circuit 150 and the backlight source 160 are running, the power consumption and the power consumption value required for the DC power converters DCV4 and

DCV5 to provide the driving power can be estimated. Therefore, the electronic device 100 does not need to use additional power sensors to sense the power consumption of the DC power converters DCV4 and DCV5. In some embodiments, the DC power converter DCV4 may be disposed in the power supply circuit 150. The DC power converter DCV5 may be disposed in the backlight source 160.

In some embodiments, at least one of the power supply circuit 150 and the backlight source 160 may be omitted. In some embodiments, the number of the functional circuits 110_1 to 110_4 of the electronic device 100 may be increased or decreased.

For example, the communication port P1 may be a communication port that complies with the RJ45 communication specification, but the disclosure is not limited thereto.

In some embodiments, the network communication interface 140 is, for example, implemented by a network interface controller (NIC), but the disclosure is not limited thereto. In some embodiments, the processor 130 can be connected to the power sensors 120_1 to 120_4 through UART or I2C transmission, but the disclosure is not limited thereto.

In some embodiments, the processor 130 is, for example, a central processing unit (CPU), or other programmable general-purpose or special-purpose microprocessors, a digital signal processor (DSP), a programmable controller, an application specific integrated circuit (ASIC), a programmable logic device (PLD), or other similar devices, or a combination thereof, which can load and execute computer programs.

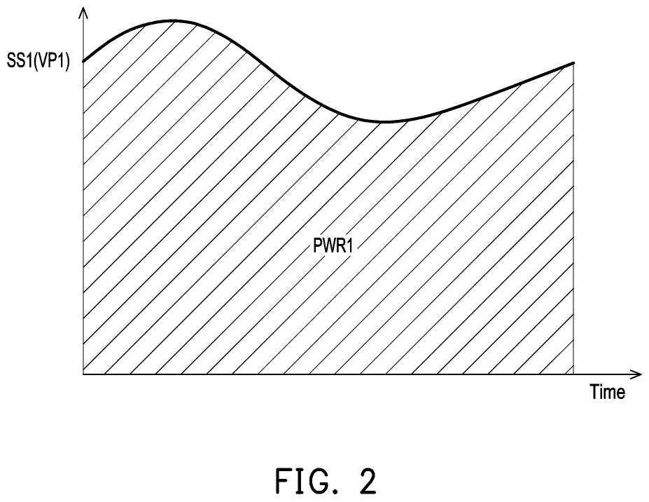

Referring to FIG. 1 and FIG. 2, FIG. 2 is a schematic diagram of power sensing signals and power values according to an embodiment of the disclosure. In an embodiment, taking the power sensing signal SS1 as an example, the processor 130 accumulates the power sensing signal SS1 over time to generate the power value PWR1 of the functional circuit 110_1. Furthermore, the processor 130 accumulates a power value VP1 (i.e., the power of the functional circuit 110_1) recorded by the power sensing signal SS1 in a time period to generate the power value PWR1 of the functional circuit 110_1. In an embodiment, the processor 130 may perform time integration on the power value VP1 recorded by the power sensing signal SS1 to generate the power value PWR1 of the functional circuit 110_1.

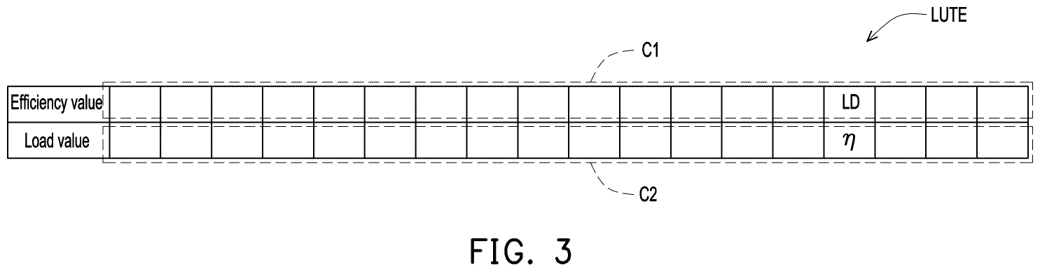

Referring to FIG. 1 and FIG. 3, FIG. 3 is a schematic diagram of an efficiency lookup table according to an embodiment of the disclosure. In an embodiment, the processor 130 obtains a current load value LD of the electronic device 100 based on a total output power PO of the electronic device 100. The processor 130 obtains a current efficiency value n of the electronic device 100 based on the current load value LD and an efficiency lookup table LUTE. Next, the processor 130 calculates a total input power PI of the electronic device 100 based on the current efficiency value n and the total output power PO. The efficiency lookup table LUTE records a plurality of efficiency values corresponding to a plurality of load values. The efficiency lookup table LUTE includes columns C1 and C2. The column C1 records several different load values. The column C2 records a plurality of efficiency values corresponding to the plurality of load values.

For example, the processor 130 may select the current efficiency value n corresponding

to the current load value LD from the plurality of efficiency values based on the current load value LD. For example, when the total output power of the electronic device 100 is equal to 300 watts, the current load value LD is equal to 95%. The processor 130 may obtain the current efficiency value n of the electronic device 100 which is equal to 90% based on the efficiency lookup table LUTE and the current load value LD. Therefore, the total input power PI is equal to 333.33 watts (i.e., PI=PO÷η). The network communication interface 140 can provide the total input power PI and the total output power PO to the host HT.

In an embodiment, the efficiency lookup table LUTE may be stored in a memory element of the electronic device 100.

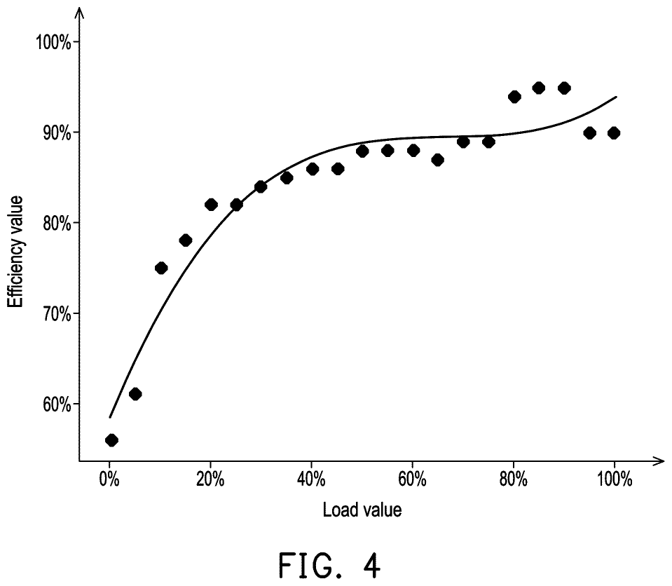

Referring to FIG. 1, FIG. 3, and FIG. 4, FIG. 4 is a schematic diagram of an efficiency value fitting function according to an embodiment of the disclosure. In an embodiment, the processor 130 establishes an efficiency value fitting function Fη(LD) corresponding to the plurality of load values based on the efficiency lookup table LUTE. The processor 130 calculates the total input power PI of the electronic device 100 based on the efficiency value fitting function Fη(LD), the current load value LD, and the total output power PO. In an embodiment, the efficiency value fitting function Fη(LD) can generate the current efficiency value n based on the current load value LD. Therefore, the total input power PI can be expressed as formula (1).

$$PI = PO \div F η ( LD ) \qquad Formula ( 1 )$$

In an embodiment, the efficiency value fitting function Fη(LD) may be an n-th degree function. n is a positive integer.

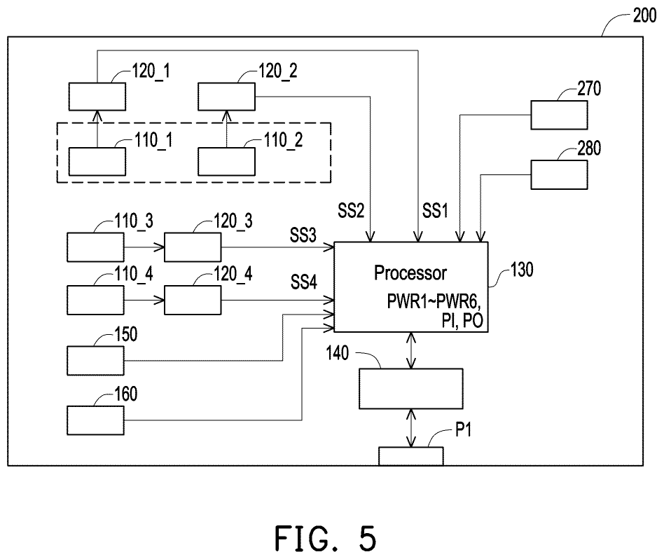

Referring to FIG. 5, FIG. 5 is a schematic diagram of an electronic device according to an embodiment of the disclosure. In an embodiment, an electronic device 200 includes the functional circuits 110_1 to 110_4, the power sensors 120_1 to 120_4, the processor 130, communication ports P1 to P6, the network communication interface 140, the power supply circuit 150, the backlight source 160, a temperature sensor 270, and an environment sensor 280. The implementations of the functional circuits 110_1 to 110_4, the power sensors 120_1 to 120_4, the processor 130, the communication ports P1 to P6, the network communication interface 140, the power supply circuit 150, and the backlight source 160 have been clearly explained in the embodiments of FIG. 1 to FIG. 4, and therefore will not be repeated here.

In an embodiment, the temperature sensor 270 is coupled to the processor 130. The temperature sensor 270 senses the temperature of the electronic device 300 to generate a temperature sensing signal. The processor 130 may use the temperature sensing signal to perform over-temperature protection operation. The environment sensor 280 is coupled to the processor 130. The environment sensor 280 senses the environment of the electronic device 300 to determine whether the electronic device 300 is being used. For example, when the brightness of the ambient light is too low and/or there is no user within a set distance, the processor 130 will determine that the electronic device 300 is not in use. Therefore, the processor 130 controls the electronic device 300 to enter the power saving mode or the sleep mode, or disable at least one of the functional circuits 110_1 to 110_4, thereby achieving the power saving effect. The environment sensor 280 may be an ambient light sensor or a proximity sensor.

The processor 130 can be connected to the power sensors 120_1 to 120_4, the temperature sensor 270, and the environment sensor 280 through UART or I²C transmission, but the disclosure is not limited thereto.

Each of the temperature sensor 270 and the environment sensor 280 has a fixed power consumption. Therefore, the processor 130 can learn the power of the temperature sensor 270 and the environment sensor 280. The processor 130 can also obtain the power values of the temperature sensor 270 and the environment sensor 280.

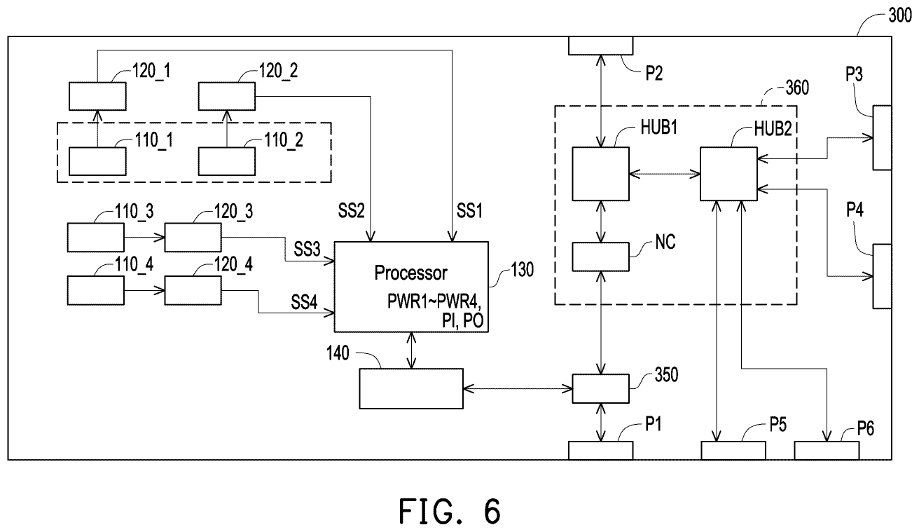

Referring to FIG. 6, FIG. 6 is a schematic diagram of an electronic device according to an embodiment of the disclosure. In an embodiment, the electronic device 300 includes the functional circuits 110_1 to 110_4, the power sensors 120_1 to 120_4, the processor 130, the communication ports P1 to P6, the network communication interface 140, a routing circuit 350, and a hub circuit 360. Similar to the embodiment of FIG. 1, the implementations of the functional circuits 110_1 to 110_4, the power sensors 120_1 to 120_4, the processor 130, and the network communication interface 140 have been clearly explained in the embodiment of FIG. 1, and therefore will not be repeated here.

In an embodiment, the routing circuit 350 is coupled to the communication port P1 and the network communication interface 140. The hub circuit 360 is coupled to the communication ports P2 to P6 and the network communication interface 140. The routing circuit 350 transmits one of the signals from the hub circuit 360 (i.e., the signals from the communication ports P2 to P6) and the signal of the communication port P1 to the network communication interface 140.

The routing circuit 350 may be implemented by a switching circuit. In addition, the routing circuit 350 transmits at least the power values PWR1 to PWR4 to the communication port P1.

In an embodiment, the hub circuit 360 may include hubs HUB1 and HUB2 and a network card NC. Therefore, the hub circuit 360 expands the maximum number of connections of the communication port. The network card NC is, for example, implemented by an RTL8153 chip, but the disclosure is not limited thereto.

For example, the communication port PI may be a communication port that complies with the RJ45 communication specification, but the disclosure is not limited thereto. The communication ports P2 to P6 can be USB connection ports of any version, but the disclosure is not limited thereto.

In some embodiments, the network card NC may be omitted.

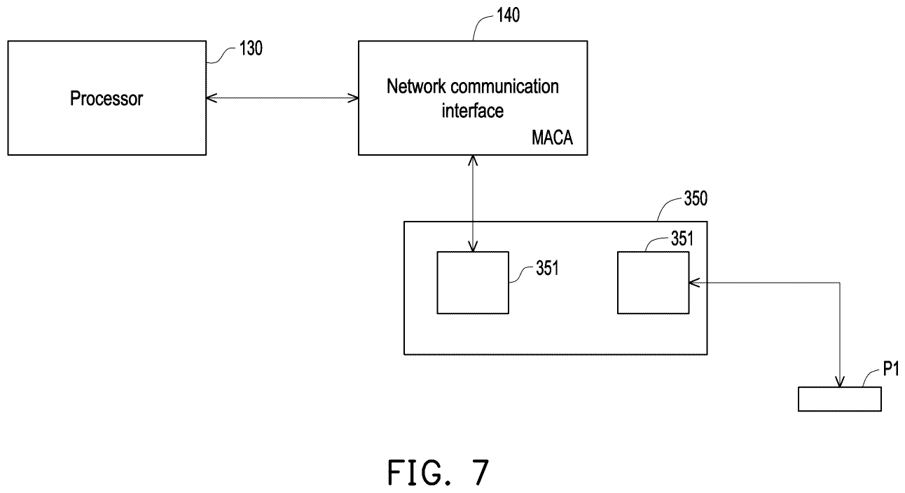

Referring to FIG. 6 and FIG. 7, FIG. 7 is a schematic diagram of a processor, a network communication interface, a routing circuit, and a communication port according to an embodiment of the disclosure. In an embodiment, FIG. 7 shows the processor 130, the network communication interface 140, the routing circuit 350, and the communication port P1. For example, the routing circuit 350 can send and receive information conforming to the Ethernet type through the communication port P1. The routing circuit 350 includes an expansion interface 351 and a port physical layer (PHY) circuit 352. The expansion interface 351 is coupled to the network communication interface 140. The expansion interface 351 receives at least the media access control (MAC) address MACA of the network communication interface 140. The expansion interface 351 can also receive power values PWR1 to PWR4.

It should be noted that the routing circuit 350 itself includes the PHY circuit 352. Therefore, when the routing circuit 350 is used for signal transmission management, the electronic device 300 does not require an additional Ethernet PHY chip.

In an embodiment, the expansion interface 351 can be connected to the network communication interface 140 through an interface such as MII or RGMII, but the disclosure is not limited thereto. The processor 130 can be connected to the network communication interface 140 through UART or I²C transmission, but the disclosure is not limited thereto.

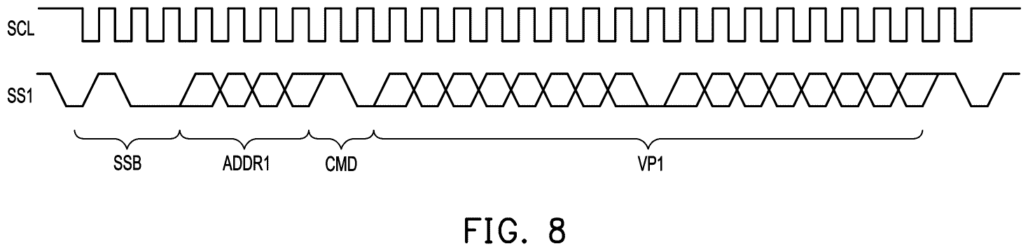

Referring to FIG. 1 and FIG. 8, FIG. 8 is a schematic diagram of a power sensing signal according to an embodiment of the disclosure. In an embodiment, the power sensor 120_1 provides the power sensing signal SS1 to the processor 130. Furthermore, the power sensor 120_1 includes a register. The register records an address ADDR1 and the power value VP1 of the functional circuit 110_1. The power sensor 120_1 may generate the power sensing signal SS1 based on a clock signal SCL. The power sensing signal SS1 includes a ready signal SSB, the address ADDR1, a command CMD, and the power value VP1.

In an embodiment, the ready signal SSB may be a header of the power sensing signal SS1. Once the processor 130 receives the ready signal SSB, the processor 130 knows to start receiving the power sensing signal SS1. The processor 130 receives the address ADDR1, the command CMD, and the power value VP1. The processor 130 reads the power value VP1 corresponding to the address ADDR1 (i.e., the address ADDR1) based on the command CMD.

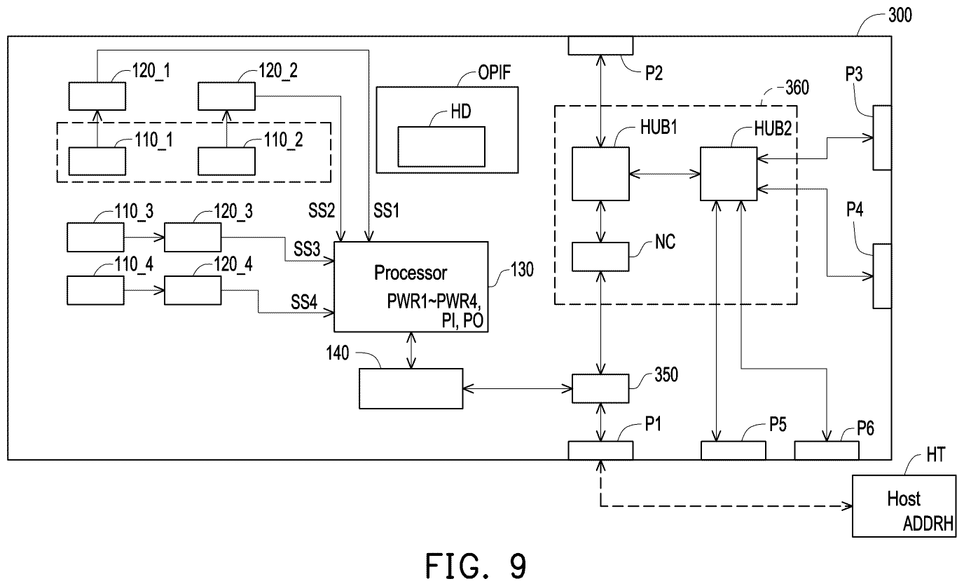

Referring to FIG. 9, FIG. 9 is a schematic diagram of an operation of an electronic device according to an embodiment of the disclosure. In an embodiment, the electronic device 300 provides an operating interface OPIF. For example, the operating interface OPIF may be a display interface provided by the functional circuit 110_1 (i.e., the display panel). In some embodiments, the operating interface OPIF may be a key, a button, or a knob. The electronic device 300 enters one of the first mode and the second mode based on an operating result of the operating interface OPIF. For example, the first mode may be client mode. The second mode may be a server mode.

In the first mode, the processor 130 allows the electronic device 300 to be inputted with an address ADDRH of the host HT. Therefore, based on the address ADDRH, the electronic device 300 can correctly transmit the power values PWR1 to PWR4, the total output power PO, and the total input power PI to the host HT through the communication port P1.

In some embodiments, the electronic device 300 can transmit the power values PWR1 to PWR4, the total output power PO, and the total input power PI to the host HT through one of the communication ports P2 to P6.

Further, in the first mode, the processor 130 controls the electronic device 300 to provide a configuration menu CMENU based on a specific operating method for inputting or selecting the address ADDRH of the host HT. For example, the operating interface OPIF may be a display interface provided by the functional circuit 110_1. The user can control the processor 130 by performing specific touch operations or key combination operations through the operating interface OPIF, so that the processor 130 controls the electronic device 300 to provide the configuration menu CMENU in the operating interface OPIF.

In an embodiment, the address ADDRH may be an IP address, a subnet mask, a gateway address, or a DNS address.

In the second mode, the processor 130 controls the network communication interface 140 to receive at least historical data of the electronic device 300 and controls the electronic device 300 to display the historical data. The historical data at least includes the power values PWR1 to PWR4.

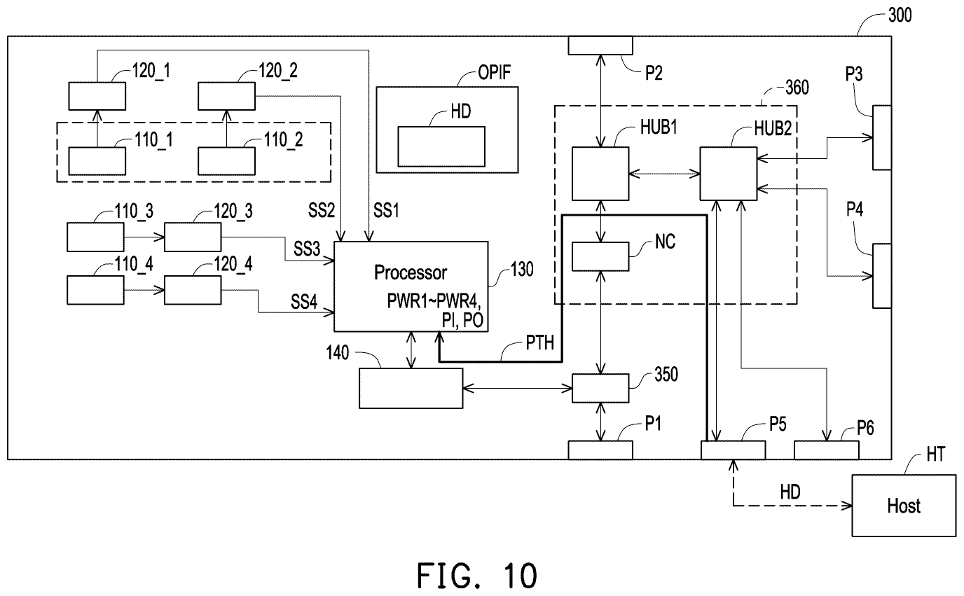

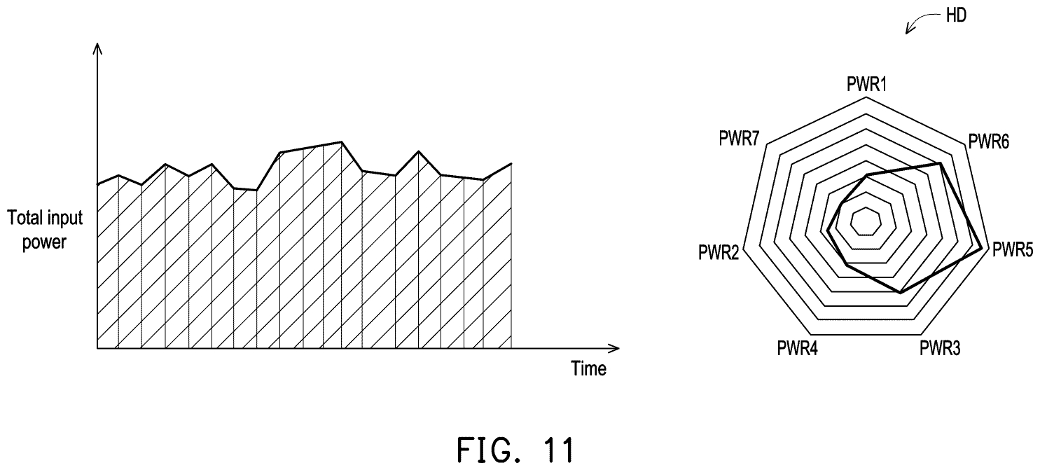

For specific explanation, please refer to FIG. 10 and FIG. 11. FIG. 10 is a schematic diagram of an operation of an electronic device according to an embodiment of the disclosure. FIG. 11 is a schematic diagram of historical data according to an embodiment of the disclosure. In an embodiment, in the second mode, the electronic device 300 receives, for example, historical data HD stored in the host HT through the communication port P5. The historical data HD may be the historical data HD of the electronic device 300. The historical data HD is transmitted to the processor 130 via the communication port P5, the hub HUB2, the hub HUB1, the network card NC, the routing circuit 350, and a path PTH of the network communication interface 140.

It should be understood that when the electronic device 300 communicates with the host HT, for example, through the communication port P1 or the communication port P2, the path PTH will be changed.

In some embodiments, the user can also view the historical data of other electronic devices through the electronic device 300. Further, the electronic device 300 is controlled to enter the second mode. In the second mode, the user logs in to the server webpage based on the user's permissions, and views the historical data of other electronic devices through the electronic device 300.

In an embodiment, the operating interface OPIF may be a display interface provided by the functional circuit 110_1. Therefore, the processor 130 displays the historical data HD in the operating interface OPIF.

In an embodiment, the historical data HD includes data of the power values PWR1 to PWR7 and data of the total input power PI. The power values PWR1 to PWR4 are the power values of the functional circuits 110_1 to 110_4, respectively. The power value PWR5 is, for example, the power value of the power supply circuit (such as the power value PWR5 in FIG. 1). The power value PWR6 is, for example, the power value of the backlight source (such as the power value PWR6 in FIG. 1). The power value PWR7 is, for example, the sensed power value of a temperature sensor (such as the temperature sensor 270 in FIG. 5). The disclosure is not limited to the presentation mode of the historical data HD in FIG. 11.

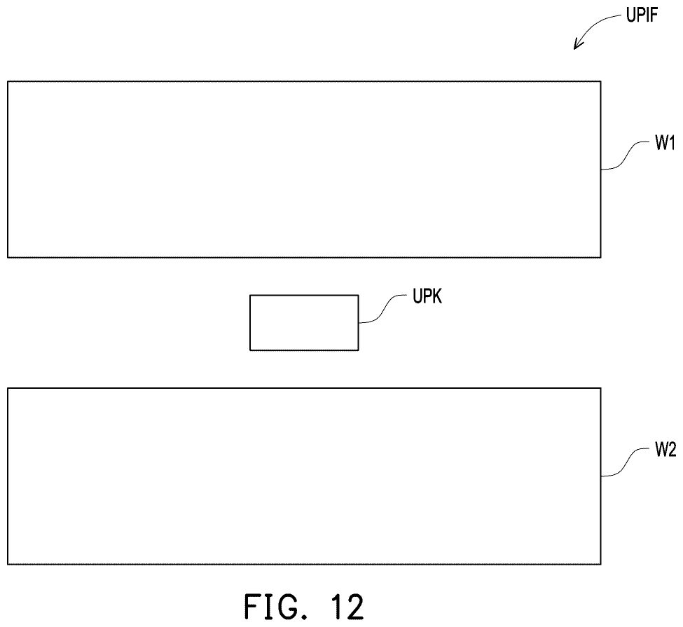

Referring to FIG. 10 and FIG. 12, FIG. 12 is a schematic diagram of an update interface according to an embodiment of the disclosure. In an embodiment, in the second mode, at least one of the application program of the processor 130 and the application program of the network communication interface 140 is updated. In the second mode, an update interface UPIF is displayed in the operating interface OPIF. The update interface UPIF includes an updateable version window W1. The updateable version window W1 lists a plurality of updateable versions of a plurality of drivers of a plurality of components in the electronic device 300. The plurality of drivers include, for example, the application program of the processor 130, the application program of the network communication interface 140, the application programs of the hubs HUB1 and HUB2, and so on. In this way, in the second mode, the user can view the updateable version for the electronic device 300 in the updateable version window W1.

The update interface UPIF also includes an update key UPK. When the update key UPK is selected, the electronic device 300 updates the plurality of components in the electronic device 300 based on the plurality of updateable versions. In this way, the electronic device 300 can achieve the update convenience of one-click update.

For example, the electronic device 300 receives the plurality of drivers from the host HT through the communication port P5. Therefore, the plurality of drivers can be transmitted to the processor 130 through the path PTH.

It should be understood that in the case where the electronic device 300 communicates with the host HT, for example, through the communication port P1 or the communication port P2, the path PTH will be changed. For example, when the electronic device 300 communicates with the host HT through the communication port P1, the plurality of drivers may be transmitted to the processor 130 through the communication port P1, the routing circuit 350, and the path PTH of the network communication interface 140.

In addition, the update interface UPIF also includes an update progress window W2. The update progress window W2 displays the update progress of the plurality of drivers. In this way, in the second mode, the user can view the update progress of the plurality of drivers in the update progress window W2.

It should be understood that the electronic devices 100 and 200 can also perform operations in the first mode and the second mode.

In an embodiment, the electronic device 300 can perform local computer training on the power sensing signals SS1 to SS4 collected by the processor 130. The electronic device 300 can perform local computer training through tools such as NanoEdgeAIstudio. The electronic device 300 generates files (such as .a and .h files) after training on the local computer. The electronic device 300 migrates the file to the processor 130. Therefore, the electronic device 300 has the machine learning capability of edge AI. The electronic device 300 can identify whether each functional module operates abnormally. When it comes to data security, the electronic device 300 or the processor 130 can build a powerful multi-layer security protection strategy and develop functions such as secure boot, random number generator for preventing hackers from observing signal patterns, dedicated encryption processor, secret key secure storage unit, tamper detection, code isolation, etc., thereby effectively protecting the data security of the electronic device 300.

In an embodiment, during the use of the electronic device 300, the user allows the electronic device 300 to upload the user's personal information or personal characteristics to the host HT. The personal characteristics are, for example, the user's voiceprint, fingerprint image, facial image, or iris image. In response to the user's personal information or personal characteristics, the host HT can learn that the user is using the electronic device 300. Therefore, the host HT produces a user-specific promotional video and provides the promotional video to the electronic device 300, thereby using the promotional video to introduce related products to the user who is using the electronic device 300.

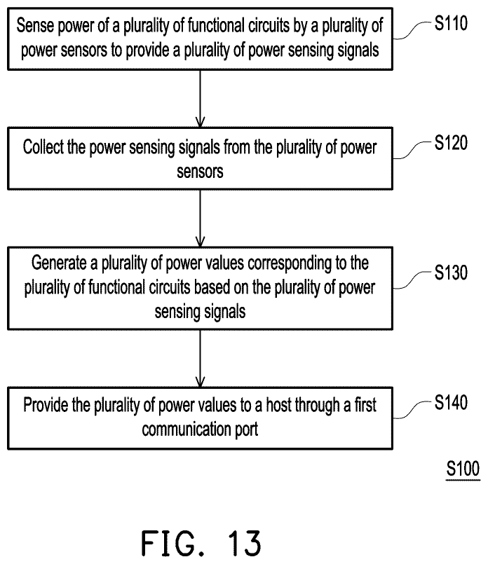

Referring to FIG. 1 and FIG. 13, FIG. 13 is a flowchart of an operating method according to an embodiment of the disclosure. In an embodiment, an operating method S100 may be applicable to the electronic device 100. The operating method S100 includes steps S110 to S140. In step S110, the power sensors 120_1 to 120_4 sense the power of the functional circuits 110_1 to 110_4 to provide the power sensing signals SS1 to SS4. In step S120, the processor 130 collects the power sensing signals SS1 to SS4 from the power sensors 120_1 to 120_4. In step S130, the processor 130 generates the power values PWR1 to PWR4 corresponding to the functional circuits 110_1 to 110_4 based on the power sensing signals SS1 to SS4. In step S140, the network communication interface 140 provides the power values PWR1 to PWR4 to the host HT through the communication port P1 (i.e., the first communication port). The implementation details of steps S110 to S140 have been clearly explained in the multiple embodiments of FIG. 1 to FIG. 10, and therefore will not be repeated here.

In summary, the electronic device communicates with the host. The electronic device includes the plurality of functional circuits, the plurality of power sensors, the processor, the communication port, and the network communication interface. The processor generates the plurality of power values corresponding to the plurality of functional circuits based on the plurality of power sensing signals. The network communication interface provides the plurality of power values to the host through the communication port. In this way, the host can track the carbon footprint of the electronic device during its usage stage.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. An electronic device for communicating with a host, comprising:
a plurality of functional circuits;
a plurality of power sensors, wherein each of the power sensors is configured to sense power of one of the functional circuits to provide a power sensing signal;
a processor, coupled to the power sensors, and configured to collect a plurality of power sensing signals from the power sensors and generate a plurality of power values corresponding to the functional circuits based on the power sensing signals;
a first communication port; and
a network communication interface, coupled to the processor and the first communication port, and configured to provide the power values to the host through the first communication port.

2. The electronic device according to claim 1, wherein the processor accumulates a first power sensing signal among the power sensing signals over time to generate a first power value among the power values.

3. The electronic device according to claim 1, wherein the processor obtains a current load value of the electronic device based on a total output power of the electronic device, obtains a current efficiency value of the electronic device based on the current load value and an efficiency lookup table, and calculates a total input power of the electronic device based on the current efficiency value and the total output power.

4. The electronic device according to claim 3, wherein:
the efficiency lookup table records a plurality of efficiency values corresponding to a plurality of load values, and the processor establishes an efficiency value fitting function corresponding to the load values based on the efficiency lookup table, and calculates the total input power of the electronic device based on the efficiency value fitting function, the current load value, and the total output power.

5. The electronic device according to claim 1, further comprising:
a routing circuit, coupled to the first communication port and the network communication interface, wherein the routing circuit comprises:
an expansion interface, coupled to the network communication interface, and configured to receive a media access control address of the network communication interface; and
a port physical layer circuit, coupled to the first communication port.

6. The electronic device according to claim 5, further comprising:
at least one second communication port; and
a hub circuit, coupled to the at least one second communication port and the routing circuit,
wherein the routing circuit transmits one of a signal from the at least one second communication port and a signal from the first communication port to the network communication interface, and transmits the power values to the first communication port.

7. The electronic device according to claim 1, wherein each of the functional circuits is one of a display panel, a panel control circuit, a connector, and a speaker.

8. The electronic device according to claim 1, further comprising:
a power supply circuit, coupled to the processor, and configured to supply power to an external device connected to the electronic device,
wherein the processor obtains a power value of the power supply circuit based on a power supply requirement of the external device.

9. The electronic device according to claim 1, further comprising:
a backlight source, coupled to the processor, and configured to provide a display light source for a display panel of the electronic device,
wherein the processor obtains a power value of the display light source based on a driving signal used by the backlight source.

10. The electronic device according to claim 1, wherein:
the electronic device provides an operating interface, and the electronic device enters one of a first mode and a second mode based on an operating result of the operating interface.

11. The electronic device according to claim 10, wherein in the first mode, the processor allows the electronic device to be inputted with an address of the host.

12. The electronic device according to claim 11, wherein in the first mode, the processor controls the electronic device to provide a configuration menu for inputting or selecting the address of the host based on a specific operating method.

13. The electronic device according to claim 10, wherein in the second mode, the processor controls the network communication interface to receive historical data of the power values of the electronic device, and controls the electronic device to display the historical data.

14. The electronic device according to claim 13, wherein in the second mode, at least one of an application program of the processor and an application program of the network communication interface is updated.

15. An operating method for communicating with a host, comprising:
sensing power of a plurality of functional circuits by a plurality of power sensors to provide a plurality of power sensing signals;
collecting the power sensing signals from the power sensors;
generating a plurality of power values corresponding to the functional circuits based on the power sensing signals; and
providing the power values to the host through a first communication port.

16. The operating method according to claim 15, wherein the step of generating the power values corresponding to the functional circuits based on the power sensing signals comprises:
accumulating a first power sensing signal among the power sensing signals over time to generate a first power value among the power values.

17. The operating method according to claim 15, further comprising:
obtaining a current load value based on a total output power;
obtaining a current efficiency value based on the current load value and an efficiency lookup table; and
calculating a total input power based on the current efficiency value and the total output power.

18. The operating method according to claim 17, wherein the efficiency lookup table records a plurality of efficiency values corresponding to a plurality of load values, and the step of calculating the total input power based on the current efficiency value and the total output power comprises:
establishing an efficiency value fitting function corresponding to the load values based on the efficiency lookup table; and
calculating the total input power based on the efficiency value fitting function, the current load value, and the total output power.

19. The operating method according to claim 15, further comprising:
receiving a media access control address of a network communication interface, and entering one of a first mode and a second mode based on an operating result of an operating interface.

20. The operating method according to claim 19, further comprising:
in the first mode, providing a configuration menu for inputting or selecting an address of the host, wherein in the second mode, historical data of the power values is received and the historical data is displayed.
